(19) United States
(12) Patent Application Publication
(10) Pub. No.: US 2012/0081517 A1
(43) Pub. Date: Apr. 5, 2012

(54) Image Processing Apparatus and Image Processing Method

(76) Inventor: Hiroaki Komaki, Tachikawa-shi (JP)

(21) Appl. No.: 13/160,183

(22) Filed: Jun. 14, 2011

(30) Foreign Application Priority Data
Sep. 30, 2010 (JP) 2010-222807

(51) Int. Cl. H04N 13/02

(52) U.S. Cl. 348/46; 348/E13.074

(57) ABSTRACT

According to one embodiment, an image processing apparatus includes a limiter, an input module, and a converter. The limiter is configured to limit an input image format according to an instruction for a 3D conversion for converting an input 2D image into a 3D image. The input module is configured to input a 2D image corresponding to an input image format based on the limitation. The converter is configured to convert the input 2D image into a 3D image.

### CROSS-REFERENCE TO RELATED APPLICATIONS

This application is based upon and claims the benefit of priority from Japanese Patent Application No. 2010-222807, filed Sep. 30, 2010; the entire contents of which are incorporated herein by reference.

### FIELD

Embodiments described herein relate generally to an image processing apparatus and an image processing method.

### BACKGROUND

Various techniques for displaying 3D images (three-dimensional images) have been developed and put to practical use. However, televisions capable of displaying three-dimensonal images (these televisions are hereinafter referred to as 3D televisions) are not so widely prevalent because 3D images are inferior to 2D images in brightness and resolution.

However, in recent years, with the advent of high-capacity optical disks such as BDs (Blu-ray) (registered trademark) and the prevalence of full-HD televisions, high-quality 3D images have been able to be reproduced based on a frame sequential method or the like. Thus, 3D televisions are expected to spread significantly in the future.

However, even now, only a small number of 3D image contents are available. Against this background, a technique (2D/3D conversion technique) has been proposed in which a 2D image content is converted into a 3D image content so that a pseudo-3D image can be generated based on the 3D mage content resulting from the conversion.

A 3D television with the 2D/3D conversion function can receive a 2D image from an external apparatus (image transmitter) such as a digital video recorder (DVR), convert the 2D image into a 3D image, and then output the 3D image.

However, the external apparatus may convert an original image format for 2D images into a predetermined image format and then output the image in the predetermined image format, depending on the capabilities of the 3D television and the like. In this case, the 3D image resulting from the conversion by the 3D television may exhibit degraded image quality. This is because when the external apparatus converts the original image format into the predetermined image format at a low conversion accuracy, then for example, the contours of objects in the converted 2D image are coarse, resulting in a low image analysis accuracy for the 2D image in the 2D/3D conversion function.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing an example of the configuration of a 2D/3D conversion apparatus (image processing apparatus) according to a first embodiment and a second embodiment and an example of a connection between the 2D/3D conversion apparatus and an external apparatus;

FIG. 2 is a flowchart illustrating an example of a passive limitation technique for an input image format according to the first embodiment; and

FIG. 3 is a flowchart illustrating an example of a passive limitation technique for the input image format according to the second embodiment.

### DETAILED DESCRIPTION

Various embodiments will be described hereinafter with reference to the accompanying drawings.

In general, according to one embodiment, an image processing apparatus includes a limiter, an input module, and a converter. The limiter is configured to limit an input image format according to an instruction for a 3D conversion for converting an input 2D image into a 3D image. The input module is configured to input a 2D image corresponding to an input image format based on the limitation. The converter is configured to convert the input 2D image into a 3D image.

A first embodiment and a second embodiment will be described below with reference to the drawings.

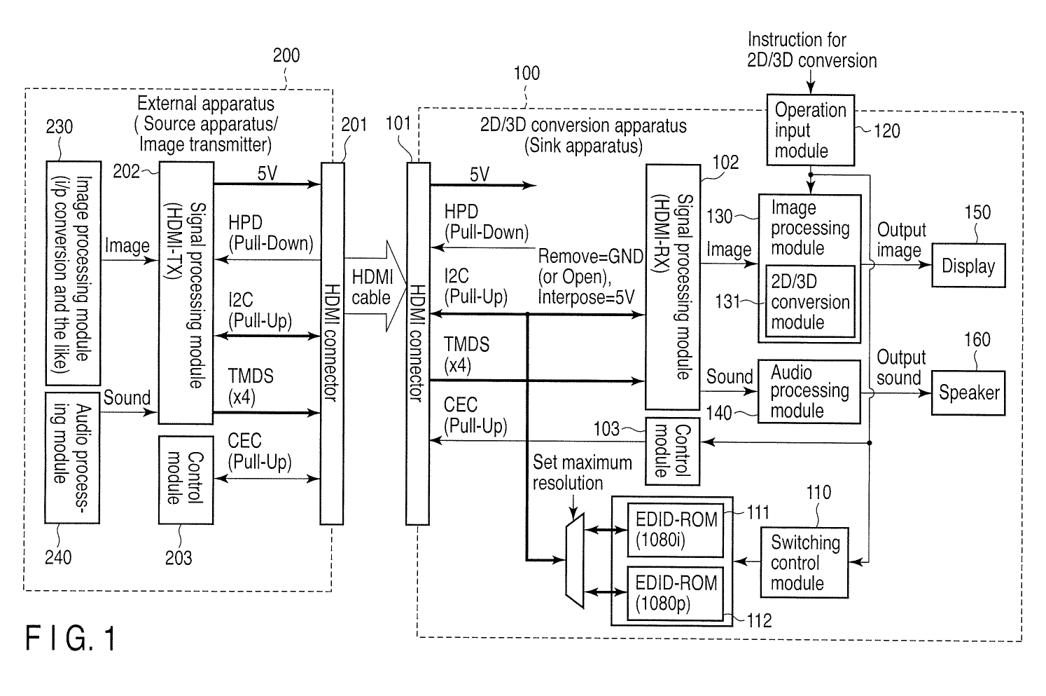

FIG. 1 is a diagram showing an example of the configuration of a 2D/3D conversion apparatus (image processing apparatus) common to the first and second embodiments and an example of a connection between the 2D/3D conversion apparatus and an external apparatus. As shown in FIG. 1, for example, the 2D/3D conversion apparatus and the external apparatus are connected together via, for example, an HDMI (High-Definition Multimedia Interface) (registered trademark).

For example, a 2D/3D conversion apparatus 100 is a digital television (DTV) that provides a 2D/3D function to convert 2D images into 3D images to enable the 3D images to be displayed. The 2D/3D conversion apparatus 100 comprises an HDMI connector 101, a signal processing module (HDMI-RX) 102, a control module 103, a switching control module (limiter) 110, EDID (Extended Display Identification Data)-ROM 111, EDID-EOM 112, an operation input module 120, an image processing module 130, a 2D/3D conversion processing module 131, an audio processing module 140, a display 150, and a speaker 160.

Furthermore, the external apparatus 200 is, for example, a digital video recorder (DVR) configured to output 2D images. Alternatively, the external apparatus 200 is a DVD player, a BD (Blu-ray [registered trademark]) player, or a set-top box. The external apparatus 200 comprises an HDMI connector 201, a signal processing module (HDMI-TX) 202, a control module 203, an image processing module 230, and an audio processing module 240.

The 2D/3D conversion apparatus 100 (HDMI-RX side) is hereinafter referred to as the sink apparatus 100. The external apparatus 200 (HDMI-TX side) is hereinafter referred to as the source apparatus 200.

When the HDMI cable is inserted between the source apparatus 200 and the sink apparatus 100, a link is established between the source apparatus 200 and the sink apparatus 100 according to the following procedure.

(1) An HPD (Hot Plug Detect) signal changes from a low level (L) to a high level (H) in response to the insertion of the HDMI cable. The signal processing module 202 of the source apparatus 200 detects the connection of the sink apparatus 100.

(2) The signal processing module 202 of the source apparatus 200 reads a first EDID or a second EDID from, for example, EDID-ROM 111 or EDID-ROM 112 of the sink apparatus 100 via DDC (Display Data Channel) (12C). The signal processing module 202 thus acquires information such as image formats accepted by the sink apparatus 100 to authenticate the sink apparatus 100. The first or second EDID includes a manufacturer, a model number, and specific information.

Furthermore, when the HDMI cable is removed from between the source apparatus 200 and the sink apparatus 100, the link between the source apparatus 200 and the sink apparatus 100 is disconnected according to the following procedure.

(3) The HPD signal changes from the high level (H) to the low level (L) in response to the removal of the HDMI cable. The signal processing module 202 of the source apparatus 200 detects the removal of the sink apparatus 100.

Then, the relationship between the 2D/3D conversion carried out by the sink apparatus 100 and an input image format for the sink apparatus will be described.

Possible original formats for image sources subjected to the 2D/3D conversion by the sink apparatus 100 are as follows.

(Image Format 480i)

A typical example of an image format 480i is an image format for analog broadcasting in North America and Japan. Furthermore, examples of the image format 480i include a DVD output image format and an image format for home SD video cameras. Formats 60i and 50i are available which allow different broadcasting schemes to be dealt with.

(Image Format 480p)

A typical example of an image format 480p is an image format for CS broadcasting in North America and Japan. Furthermore, examples of the image format 480p include a DVD output image format and a BD output image format.

(Image Format 720p)

A typical example of an image format 720p is an image format for HDTVs in North America. Furthermore, examples of the image format 720p include a BD output image format and an image format for home HD video cameras (AVCHD or the like). Formats 60p and 50p are available which allow different broadcasting schemes to be dealt with. Moreover, a format 24p is available which allows films to be dealt with.

(Image Format 1080i)

A typical example of an image format 1080i is an image format for digital high-definition broadcasting in Japan. Furthermore, examples of the image format 1080i include a BD output image format (1080i recording) and an image format for home HD video cameras (AVCHD [registered trademark] or the like). Formats 60i and 50i are available which allow different broadcasting schemes to be dealt with.

(Image Format 1080/24p)

A typical example of an image format 1080/24p is a BD output image format. Furthermore, an example of the image format 1080/24p may be the image format (AVCHD) for home HD video cameras.

(Image Format 1080/60p)

An example of an image format 1080/60p is an image format for some home HD video cameras (this image format is incompatible with AVCHD). An image format specified for BD/AVCHD does not accept a 180/60p resolution.

The source apparatus 200, for example, DVR, provides a function to convert the image formats 480i, 480p, 720p, and 1080i into the image format 1080/60p (upscaling). For example, the image processing module 230 converts the image formats 480i, 480p, 720p, and 1080i into the image format 1080/60p (upscaling).

In a process of converting the image formats 480i and 480p into the image format 1080/60i (upscaling), the number of pixels is converted (increased). Thus, converted images contain interpolation information.

Also in a process of converting the image format 720p into the image format 1080/60p, the number of pixels is converted (increased). Thus, converted images contain interpolation information.

In a process of converting the image format 1080i into the image format 1080/60p, an i/p conversion process is executed. For example, the image processing module 230 carries out the i/p conversion process. That is, the quality of the image format 1080/60p resulting from the conversion process depends greatly on the image processing capability (i/p conversion process capability). For example, in the i/p conversion process, a process of synthesizing top and bottom fields is executed on still image areas. A pixel interpolation process based on doubling or the like is executed on moving image areas within each field.

The range and accuracy of motion detection carried out in image processing (i/p conversion process), and schemes for pixel interpolation and generation, and the like vary with the type of source apparatus 200. The source apparatus 200 executes an i/p conversion process to generate an image format 1080/60p including pixel interpolation information and the like. Thus, the quality of the image format 1080/60p resulting from the conversion process depends on the image processing capability (i/p conversion process capability) of the source apparatus 200. For example, the image format 1080/60p output by the source apparatus 200 with a low image processing capability (low i/p conversion process capability) is likely to have low image quality.

Furthermore, in many cases, an image source for the image format 1080p is film for movies and the like. That is, in many cases, the image source for the image format 1080p is in the image format 1080/24p. In converting the image format 1080i into the image format 1080/24p, the source apparatus 200 avoids application of the i/p conversion process. The application of the i/p conversion process is avoided in order to avoid degradation of image quality as a result of an authoring process. Moreover, a 2-3 pulldown process allows the image format 1080/24p for film to be converted into the image format 1080i without losing pixel information.

Consequently, in subjecting an image from the source apparatus 200 to a 2D/3D conversion, the sink apparatus 100 desires to receive, from the source apparatus 200, an image in the image format 1080i rather than an image in the image format 1080p. This is because the image in the image format 1080p output by the source apparatus 200 may have low quality as described above. The image in the image format 1080p output by the source apparatus 200 may have unknown quality resulting from the i/p conversion process executed by the source apparatus 200. For example, if the source apparatus has a low i/p conversion process capability, the image in the image format 1080p generated through the i/p conversion process by the source apparatus 200 is likely to have low quality. On the other hand, an image in the image format 1080i output by the source apparatus 200 is likely to have quality equivalent to that of the original image.

Thus, in converting a 2D image from the source apparatus 200 into a 3D image, the sink apparatus 100 limits the input image format from the source apparatus 200 to receive an input 2D image corresponding to an input image format based on the limitation. The source apparatus 200 then converts the input 2D image into a 3D image. For example, the sink apparatus 100 sets the image format 1080i to be an upper limit for the input image format from the source apparatus 200. That is, the sink apparatus 100 limits the input image format so as to accept images in the image formats 480i, 480p, 720p, and 1080i, while avoiding acceptance of images in the image format 1080p. Hence, the sink apparatus 100 can minimize pixel interpolation in the source apparatus 200 and thus use images more similar to the original images (information).

Here, a 2D/3D conversion for converting a 2D image into a 3D image will be described in a supplementary manner. The 2D/3D conversion process module 131 of the sink apparatus 100 executes the 2D/3d conversion process of converting a 2D image into a 3D image.

For example, in the 2D/3D conversion process, the 2D/3D conversion process module 131 analyzes an input 2D image, and detects objects such as persons in the input 2D image. The 2D/3D conversion process module 131 further detects the front and behind positional relation of each objects (depth positional relation of the objects) and deforms the objects as required to generate a 3D image. At this time, when having low quality, the input 2D image is analyzed at a low analysis accuracy, resulting in a 3D image of low quality. For example, if the input 2D image contains a noise component or the like as a result of execution of the above-described i/p conversion process, the accuracy of detection of objects such as persons and of the front and behind positional relation of each objects (front-back relationship among the objects) may be reduced, resulting in a 3D image of low quality. Thus, the quality of the input 2D image needs to be prevented from being degraded by image processing (i/p conversion process) executed by the source apparatus 200. This allows the 3D image to be prevented from having degraded quality as a result of the 2D/3D conversion process executed by the sink apparatus 100.

Thus, in converting a 2D image from the source apparatus 200 into a 3D image, the sink apparatus 100 limits the input video format from the source apparatus 200. Now, description will be given of a passive limitation technique for the input image format according to the first embodiment and an active limitation technique for the input image format according to the second embodiment.

### First Embodiment

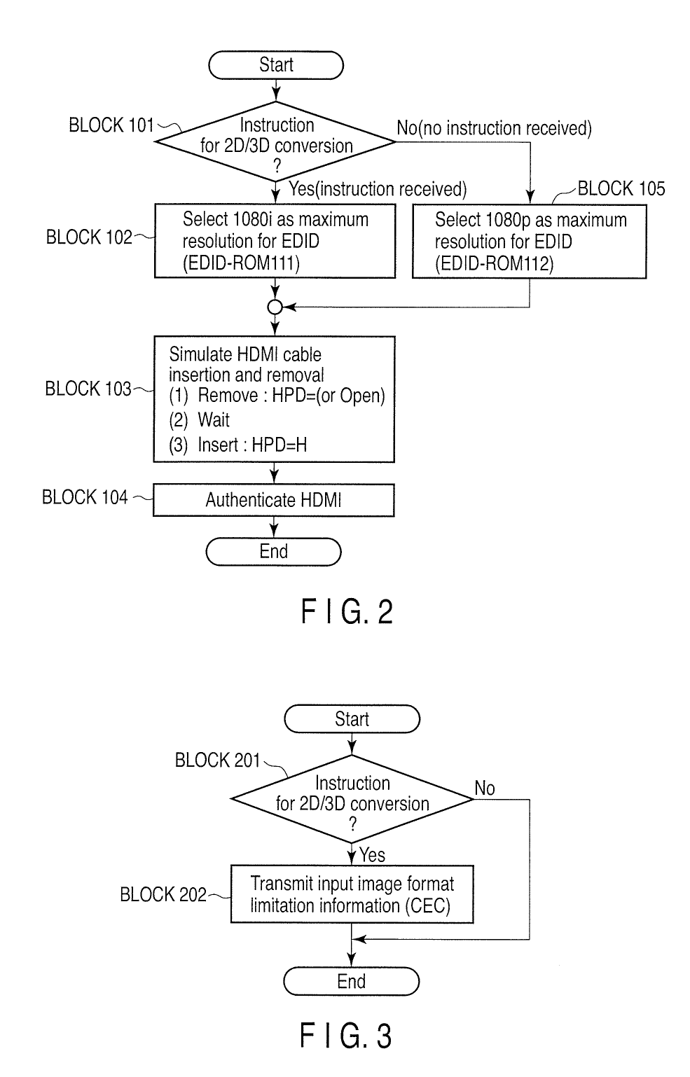

In a first embodiment, the passive limitation technique based on switching between EDID-ROM 111 and EDID-ROM 112 will be described. FIG. 2 is a flowchart illustrating an example of the passive limitation technique for the input image format according to the first embodiment.

EDID-ROM 111 is configured to store a first accepted image format list. The first accepted image format list contains information on acceptance of, for example, the image formats 480i, 480p, 720p, and 1080i. That is, the first accepted image format list contains information indicating that input of the maximum resolution of 1080i is accepted.

EDID-ROM 112 is configured to store a second accepted image format list. The second accepted image format list contains information on acceptance of, for example, the image formats 480i, 480p, 720p, 1080i, and 1080p. That is, the second accepted image format list contains information indicating that input of the maximum resolution of 1080p is accepted.

In other words, the first accepted image format list contains information indicating that input of the image format 1080i is accepted, whereas input of the image format 1080p is not accepted. The second accepted image format list contains information indicating that input of both the image formats 1080i and 1080p is accepted.

For example, during initial setting, the switching control module (limiter) 110 of the sink apparatus 100 selects EDID-ROM 112 and sets EDID-ROMs 112 and 111 so that EDID-ROM 112 can be read by the source apparatus 200, whereas EDID-ROM 111 cannot be read by the source apparatus 200. That is, the switching control module 110 selects the maximum resolution of 1080p during the initial setting.

For example, when the source apparatus 200 and the sink apparatus 100 are connected together via the HDMI cable, the source apparatus 200 authenticates the sink apparatus 100. Then, the source apparatus reads data from EDID-ROM 112 of the sink apparatus 100 to acquire information such as the image formats accepted by sink apparatus 100. Thus, the source apparatus 200 detects that the sink apparatus 100 supports the maximum resolution of 1080p.

The operation input module 120 receives an instruction for a 2D/2D conversion (BLOCK 101, YES). The operation input module 120 then notifies the switching control module 110 and the image processing module 130 of the instruction for the 2D/3D conversion. The operation input module 120 may be a control panel provided on the sink apparatus 100 or a light receiving unit configured to receive an optical signal from a remote controller that controls the operation of the sink apparatus 100.

In response to the instruction for the 2D-3D conversion, the switching control module (limiter) 110 selects EDID-ROM 111 and sets EDID-ROMs 111 and 112 so that EDID-ROM 111 can be read by the source apparatus 200, whereas EDID-ROM 112 cannot be read by the source apparatus 200. That is, the switching control module 110 selects the maximum resolution of 1080i in response to the instruction for the 2D/3D conversion (BLOCK 102).

In order to allow the source apparatus to recognize that EDID-ROM 111 has been set to be readable, the signal processing module 102 simulates insertion and removal of the HDMI cable (BLOCK 103). For example, the signal processing module 102 controls the HPD signal to the low level so as to simulate a state in which the HDMI cable is removed. Moreover, a predetermined time later, the signal processing module 102 controls the HPD signal to the high level so as to simulate a state in which the HDMI cable is inserted.

In response, the source apparatus authenticates the sink apparatus 100 (BLOCK 104). During the authentication, the source apparatus 200 reads data from EDID-ROM 111 of the sink apparatus 100 to acquire information indicative of, for example, the image formats accepted by the sink apparatus 100. Thus, the source apparatus 200 detects that the sink apparatus 100 accepts the maximum resolution of 1080i.

If the source apparatus 200 transmits an image and a sound to the sink apparatus 100, then the source apparatus 200 outputs, for example, an image in the image format 1080i and a sound in a predetermined audio format via the HDMI connector 201. The sink apparatus 100 receives the image in the image format 1080i and the sound in the predetermined audio format via the HDMI connector 101. The signal processing module 102 of the sink apparatus 100 inputs the image in the image format 1080i to the image processing module 130, while inputting the sound in the predetermined audio format to the audio processing module 140.

In response to the instruction for the 2D/3D conversion transmitted from the operation input module 120, the 2D/3D conversion module 131 of the image processing module 130 converts the image in the image format 1080i (2D image) into a 3D image and then outputs the 3D image. The display 150 then displays the 3D image. Furthermore, the audio processing module 140 applies predetermined audio processing to the sound in the predetermined audio format and then outputs the sound subjected to the predetermined audio processing. The speaker 160 outputs the sound subjected to the predetermined audio processing.

On the other hand, if the operation input module 120 does not receive the instruction for the 2D/3D conversion (BLOCK 101, NO), the operation input module 120 does not notify the switching control module 110 and the image processing module 130 of the instruction for the 2D/3D conversion.

In response to no instruction for the 2D/3D conversion (when the switching control module 110 has not received the instruction for the 2D/3D conversion for a predetermined time), the switching control module (limiter) 110 selects EDID-ROM 112 and sets EDID-ROMs 112 and 111 so that EDID-ROM 112 can be read by the source apparatus 200, whereas EDID-ROM 111 cannot be read by the source apparatus 200. That is, the switching control module 110 selects the maximum resolution of 1080p in response to no instruction for the 2D/3D conversion (when the switching control module 110 has not received the instruction for the 2D/3D conversion for the predetermined time) (BLOCK 105).

If the switching control module (limiter) 110 does not receive the 2D/3D conversion instruction, the limitation process may be ended without carrying out the processing in BLOCK 105, BLOCK 103, and BLOCK 104.

In order to allow the source apparatus to recognize that EDID-ROM 112 has been set to be readable, the signal processing module 102 simulates insertion and removal of the HDMI cable (BLOCK 103). For example, the signal processing module 102 controls the HPD signal to the low level so as to simulate a state in which the HDMI cable is removed. Moreover, a predetermined time later, the signal processing module 102 controls the HPD signal to the high level so as to simulate a state in which the HDMI cable is inserted.

In response, the source apparatus 200 authenticates the sink apparatus 100 (BLOCK 104). During the authentication, the source apparatus 200 reads data from EDID-ROM 112 of the sink apparatus 100 to acquire information indicative of, for example, the image formats accepted by the sink apparatus 100. Thus, the source apparatus 200 detects that the sink apparatus 100 accepts the maximum resolution of 1080p.

If the source apparatus 200 transmits an image and a sound to the sink apparatus 100, then for example, the source apparatus 200 converts the original image format into the image format 1080p, and outputs the image in the image format 1080p and a sound in a predetermined audio format via the HDMI connector 201. The sink apparatus 100 receives the image in the image format 1080p and the sound in the predetermined audio format via the HDMI connector 101. The signal processing module 102 of the sink apparatus 100 inputs the image in the image format 1080p to the image processing module 130, while inputting the sound in the predetermined audio format to the audio processing module 140.

The image processing module 130 applies predetermined image processing to the image in the image format 1080p (2D image), and outputs the image subjected to the predetermined image processing. The display 150 displays the image subjected to the predetermined image processing. Furthermore, the audio processing module 140 applies predetermined audio processing to the sound in the predetermined audio format and then outputs the sound subjected to the predetermined audio processing. The speaker 160 outputs the sound subjected to the predetermined audio processing.

In the technique described in the present embodiment, the sink apparatus 100 selectively uses the two types of EDID-ROMs to present the maximum resolution of 1080i or 1080p to the source apparatus 200. Alternatively, for example, the sink apparatus 100 may comprise a controller with a 12C-Slave IF to transmit any EDID (for example, information indicating that the image format 1080p is not supported) and to receive an image in the image format 1080i from the source apparatus 200.

### Second Embodiment

In a second embodiment, an active limitation technique based on CEC (Consumer Electronics Control) specified in the HDMI standards will be described below. FIG. 3 is a flowchart showing an example of the active limitation technique for the input image format according to the second embodiment.

The active limitation that will be described in the second embodiment and the passive limitation described in the first embodiment may be used together. Furthermore, if the active limitation that will be described in the second embodiment and the passive limitation described in the first embodiment are not used together, that is, if the active limitation that will be described in the second embodiment is independently used, EDID-ROM 111 is not required. Furthermore, the operation of switching between EDID-ROM 111 and EDID-ROM 112 is not required, and EDID-ROM 112 is independently used.

For example, during the initial setting, the switching control module (limiter) 110 of the sink apparatus 100 sets EDID-ROM 112 to be readable. When the source apparatus 200 and the sink apparatus 100 are connected together via the HDMI cable, the source apparatus 200 authenticates the sink apparatus 100. The source apparatus 200 acquires, from EDID-ROM 112 of the sink apparatus 100, information indicative of, for example, the image formats accepted by the sink apparatus 100. Thus, the source apparatus 200 detects that the sink apparatus 100 accepts the maximum resolution of 1080p.

Thereafter, the operation input module 120 receives an instruction for a 2D/3D conversion (BLOCK 201, YES). The operation input module 120 then notifies the control module 103 and the image processing module 130 of the instruction for the 2D/3D conversion.

In response to the instruction for the 2D-3D conversion, the control module 103 controls transmission of input image format limitation information (BLOCK 202). For example, in response to the instruction for the 2D-3D conversion, the control module 103 controls transmission of CEC containing the input image format limitation information. The control module 103 thus transmits the CEC containing the input image format limitation information to the source apparatus 200 via the HDMI connector 101.

For example, the input image format limitation information serves to request the original image with the image format thereof unconverted. Alternatively, the input image format limitation information serves to inhibit upconversions. Alternatively, the input image format limitation information serves to inhibit i/p conversions.

The source apparatus 100 receives the input image format limitation information via the HDMI connector 201. In transmitting an image and a sound to the sink apparatus 100, the source apparatus 200 outputs an original image (for example, an image in the image format 1080i) to which a process of converting the image format is not applied and a sound in a predetermined audio format via the HDMI connector 201. The sink apparatus 100 receives the image in the image format 1080i and the sound in the predetermined audio format via the HDMI connector 101. The signal processing module 102 of the sink apparatus 100 inputs the image in the image format 1080i to the image processing module 130, while inputting the sound in the predetermined audio format to the audio processing module 140.

In response to the instruction for the 2D/3D conversion transmitted from the operation input module 120, the 2D/3D conversion module 131 of the image processing module 130 converts the image in the image format 1080i (2D image) into a 3D image and then outputs the 3D image. The display 150 then displays the 3D image. Furthermore, the audio processing module 140 applies predetermined audio processing to the sound in the predetermined audio format and then outputs the sound subjected to the predetermined audio processing. The speaker 160 outputs the sound subjected to the predetermined audio processing.

On the other hand, if the operation input module 120 does not receive the instruction for the 2D/3D conversion (BLOCK 201, NO), the operation input module 120 does not notify the switching control module 110 and the image processing module 130 of the instruction for the 2D/3D conversion. In response to no instruction for the 2D/3D conversion (when the switching control module 110 has not received the instruction for the 2D/3D conversion for a predetermined time), the control module 103 avoids transmitting the input image format limitation information.

In transmitting an image and a sound to the sink apparatus, the source apparatus 200 pre-transmits an image in a predetermined image format to the sink apparatus 100 based on the information acquired from EDID-ROM 112 of the sink apparatus 100 and which is indicative of, for example, the image formats accepted by the sink apparatus 100. For example, the source apparatus 200 converts the image format of the original image into the image format 1080p. The source apparatus then outputs the image in the image format 1080p and the sound in the predetermined audio format via the HDMI connector 201. The sink apparatus 100 receives the image in the image format 1080p and the sound in the predetermined audio format via the HDMI connector 101. The signal processing module 102 of the sink apparatus 100 inputs the image in the image format 1080p to the image processing module 130, while inputting the sound in the predetermined audio format to the audio processing module 140.

The image processing module 130 applies predetermined image processing to the image in the image format 1080p (2D image), and outputs the image subjected to the predetermined image processing. The display 150 displays the image subjected to the predetermined image processing. Furthermore, the audio processing module 140 applies predetermined audio processing to the sound in the predetermined audio format and then outputs the sound subjected to the predetermined audio processing. The speaker 160 outputs the sound subjected to the predetermined audio processing.

The process of limiting the input image format according to the first embodiment (passive limitation process) and the process of limiting the input image format according to the second embodiment (active limitation process) will be summarized.

The sink apparatus 100 can execute the process of limiting the input image format as described above. Thus, the sink apparatus 100 can inhibit the source apparatus 200 from carrying out i/p conversions and thus receive images not subjected to i/p conversions (images not subjected to pixel interpolation). That is, the sink apparatus 100 can receive and subject images with the original quality to 2D/3D conversions. Hence, the sink apparatus 100 can carry out stable 2D/3D conversions regardless of the image processing capability of the source apparatus 200.

The 2D/3D conversion process module 131 of the sink apparatus 100 may execute a 2D/3D conversion process directly on an image in the image format 1080i transmitted by the source apparatus 200. Alternatively, the image processing module 130 of the sink apparatus 100 may convert the image in the image format 1080i transmitted by the source apparatus 200, into an image in the image format 1080p, before the 2D/3D conversion process module 131 executes a 2D/3D conversion process on the image in the image format 1080p.

In the case described in the first and second embodiments, in response to execution of the 2D/3D conversion process, the sink apparatus limits the image format from the source apparatus 200. However, for example, the sink apparatus 100 may limit the image format in response to execution of a process of improving image quality. This is because the process of improving the image quality can be more effectively achieved by improving the image quality of an image with the original quality than by improving the image quality of an image generated by the source apparatus 200 and containing interpolation information with unknown quality.

For example, the process of improving image quality may be a super-resolution process. The super-resolution process involves estimating original pixel values based on an image signal with a low resolution corresponding to a first resolution to increase the number of pixels, thus recovering an image signal with a high resolution corresponding to a second resolution. Here, the “original pixel values” refer to the values of pixels in an image signal obtained by using a camera with the high resolution (second resolution) to capture an image of the same subject from which an image signal with the low resolution (first resolution) has been obtained. Furthermore, “estimating original values . . . to increase the number of pixels” means that the characteristics of a target image are determined to estimate the original pixel values starting with images with a high correlation within the same frame or between frames and that the estimated values are associated with new pixels. That is, the correlation between images is utilized.

More specifically, first, an original input image is subjected to an upconvert process to create a temporary full-HD high-resolution image. That is, based on information on adjacent pixels, appropriate pixels are interpolated between the adjacent pixels to create a temporary full-HD high-resolution image.

Then, based on an image capture model function, the temporary full-HD high-resolution image is downconverted into an image with the same resolution as that of the original image. The image capture model function allows mathematical reproduction of the same process as that carried out by a common camera to convert information from an image capture element into an image signal.

The image resulting from the downconversion needs to be the same as the original input image. However, a calculation error or the like during the upconvert process may cause a difference between the image resulting from the downconversion and the original input image. The difference is detected, and the image is corrected with reference to information on surrounding pixels or the like so as to prevent calculation errors. Thus, an output image based on the super-resolution process is generated; the output image is very similar to the original input image.

That is, the super-resolution process is a technique to compare an image resulting from downconversion with the original input image to restore a signal expected to be otherwise obtained from the original input image. Repetition of the comparison and restoration process allows the accuracy of the super-resolution process to be improved. Thus, the super-resolution process may involve a single execution of the comparison and restoration process or a plurality of repetitions of the comparison and restoration process. With much time available, for example, if recorded images are to be viewed later, the comparison and restoration process may be repeated a number of times during the super-resolution process.

The super-resolution process can also be implemented using well-known, common techniques disclosed in, for example, Jpn. Pat. Appln. KOKAI Publication Nos. 2007-310837, 2008-98803, and 2000-188680.

The first and second embodiments provide an image processing apparatus and an image processing method which are excellent in preventing possible degradation of quality of 3D images resulting from 2D/3D conversions.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a limiter configured to limit an input image format according to an instruction for a 3D conversion for converting an input 2D image into a 3D image;
an input module configured to input a 2D image corresponding to an input image format based on the limitation; and
a converter configured to convert the input 2D image into a 3D image.

2. The apparatus of claim 1, wherein the limiter is configured to set a first accepted image format list for limiting input of a predetermined image format according to the instruction for the 3D conversion.

3. The apparatus of claim 2, wherein the limiter is configured to set, during initial setting, a second accepted image format list for accepting input of the predetermined image format and to set the first accepted image format list instead of the second accepted image format list according to the instruction for the 3D conversion.

4. The apparatus of claim 3, wherein the limiter is configured to set the first accepted image format list for avoiding acceptance of input of an image format 1080p or to set the second accepted image format list for accepting input of the image format 1080p.

5. The apparatus of claim 3, wherein the limiter is configured to set the first accepted image format list for accepting input of an image format 1080i while avoiding acceptance of input of the image format 1080p or to set the second accepted image format list for accepting input of the image format 1080i and the image format 1080p.

6. The apparatus of claim 3, wherein the limiter is configured to set the first or second accepted image format list to be readable by an external apparatus.

7. The apparatus of claim 4, wherein the limiter is configured to set the first or second accepted image format list to be readable by an external apparatus.

8. The apparatus of claim 5, wherein the limiter is configured to set the first or second accepted image format list to be readable by an external apparatus.

9. The apparatus of claim 1, wherein the limiter us configured to request an original image from the external apparatus according to the instruction for the 3D conversion.

10. The apparatus of claim 1, wherein the limiter us configured to request an original image with an image format thereof unconverted from the external apparatus according to the instruction for the 3D conversion.

11. The apparatus of claim 1, further comprising:
a display configured to display the 3D image resulting from the conversion by the converter.

12. An image processing method comprising:
limiting an input image format according to an instruction for a 3D conversion for converting a 2D image into a 3D image;
inputting an input 2D image corresponding to an input image format based on the limitation; and
converting the input 2D image into a 3D image.
